(19) United States
(12) Patent Application Publication
(10) Pub. No.: US 2004/0221480 A1
(43) Pub. Date: Nov. 11, 2004

(54) Device for drying a paper web

(76) Inventors: Rudolf Greimel, Stattegg-Graz (AT); Wilhelm Mausser, Graz (AT); Klaus Gissing, Judendorf-Strassengel (AT); Jorg Baubock, Graz (AT)

Correspondence Address: ALIX YALE & RISTAS LLP, 750 MAIN STREET, SUITE 1400, HARTFORD, CT, 06103, US

(21) Appl. No.: 10/832,073

(22) Filed: Apr. 26, 2004

(30) Foreign Application Priority Data
Apr. 29, 2003 (AT) A 648/2003

(51) Int. Cl. F26B 3/00

(52) U.S. Cl. 34/618

(57) ABSTRACT

A device for drying a paper web has a drying drum mounted at least partially inside a housing, whereby the cylinder wall of the drying drum is provided with a large number of apertures or openings so that hot air can flow through the cylinder wall, a heating device to generate hot air, a feed device to apply the hot air to the paper web, and a device to carry off the air containing moisture. In order to permit a compact design, the housing surrounds at least one hood which partly encloses a cylinder wall of the drying drum with the heating device being located inside the hood. Both the feed device and the heating device should be located preferably inside the hood.

### BACKGROUND OF THE INVENTION

This invention relates generally to apparatus for drying a paper web. More particularly, the present invention relates to apparatus for drying a paper web, with a drying drum mounted at least partially inside a housing, whereby the cylinder wall of the drying drum is provided with a large number of apertures or openings so that hot air can flow through the cylinder wall, with a heating device to generate hot air, a feed device to apply the hot air to the paper web, and with a device to carry off the air containing moisture.

According to the state of the art, there are housings that are used to distribute and even out the flow of hot air, while the circulating air system with the fans and heating device, e.g. a burner, are located outside the housing. Since plants of this though air dryer type require only medium pressures, but large air volume flows, only very large air ducts can be considered. However there is often not enough space available for this, particularly in rebuilds of existing plants, but also in new plants.

### SUMMARY OF THE INVENTION

The invention has the object of providing a device of the type (through air dryer) mentioned above and which permits a very compact design.

In the invention, the heating device is built into the hood, thus no additional space is needed for the heating device. A further advantage is that the space required for the air ducts can also be reduced because one air duct that is required by the state of the art, leading from the heating device to the hood, is no longer needed.

In a preferred embodiment of the invention, the feed and heating devices are mounted inside the hood. Thus, the air is heated shortly before going through the feeding device onto the paper web on the drying drum.

In this embodiment, it is an advantage to have a device to distribute and even out the flow between the heating and the feed devices. This guarantees even impingement of the hot air on the paper web and the drying drum.

If the device to carry off the air containing moisture is a suction hood, partially enclosing the cylinder wall of the drying drum and which is surrounded by the housing, the heating device can, however, also be located in the suction hood as an alternative.

Instead of using a suction hood that partially covers the cylinder wall of the drying drum, one face end of the drying drum can be left open and the device to carry off air containing moisture can be connected up to this face end. This design lends itself to applications where, for example, there is more space at the face end of the drying drum than at the circumference of the drum opposite the feed device.

### BRIEF DESCRIPTION OF THE DRAWINGS

The present invention may be better understood and its numerous objects and advantages will become apparent to those skilled in the art by reference to the accompanying drawings in which:

FIG. 1 is a schematic cross-sectional view of a first embodiment of a device in accordance with the invention;

FIG. 2 is a sectional side view of the device of FIG. 1;

FIG. 3 is a schematic cross-sectional view of a second embodiment of a device in accordance with the invention; and

FIG. 4 is a sectional side view of the device of FIG. 3.

### DETAILED DESCRIPTION OF THE PREFERRED EMBODIMENT

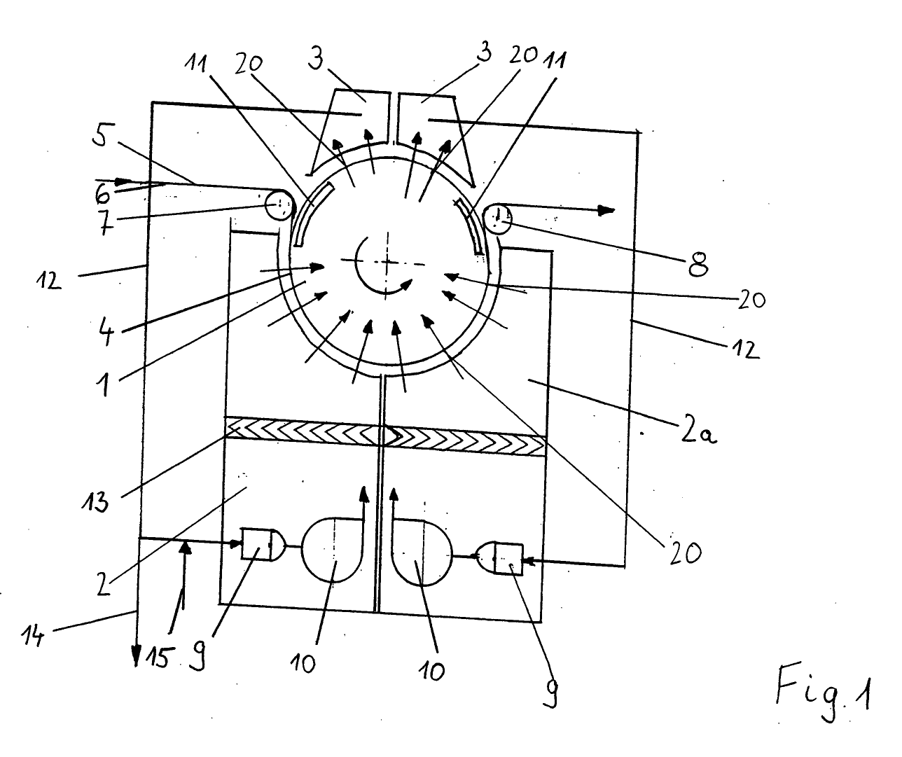

In FIG. 1, there is a schematic section of an initial embodiment of the invention, where a drying drum 1 is surrounded by a housing largely comprising two parts. The first part of the housing is formed by a lower hood 2, which partly encloses one cylinder wall 4 of the drying drum 1. The second part of the housing is formed by a suction hood 3, which also partly encloses the cylinder wall of the drying drum.

The paper web 5 to be dried, which is carried by a drying fabric running over a deflection roll 7 onto the drying drum 1 and carried away from the drying drum 1 again over a deflection roll 8 after the drying process, is wrapped round part of the cylinder wall 4, which rotates in anti-clockwise direction.

The cylinder wall 4 of the drying drum 1 is provided with a large number of apertures or openings 20 so that hot air that is used to dry the paper web 5 can flow through the cylinder wall. This hot air is generated by two heating devices 9 located in the bottom hood 2 and which, in the present embodiment example, are gas-heated or oil-heated burners. The hot air generated by the burners 9 is carried onward by fans 10 and passes through the device 13 for distributing and evening out the flow of hot air into a feed device 2a. This guarantees that the hot air impinges evenly onto the paper web 5 throughout its passage through the bottom hood 2 and that the paper web is thus dried.

The suction hood 3 opposite the bottom hood 2 is located in the area between the deflection rolls 7 and 8 and draws in the hot air that leaves the drying drum 1 through the cylinder wall 4 in this area. A suction device can be mounted in the suction hood 3, but is not absolutely necessary if the fans 10 have sufficient capacity.

Inside the drum, seals 11 are provided between the suction hood 3 and the bottom hood 2, i.e. in those areas where the deflection rolls 7 and 8 are located, to prevent hot air from escaping from the drum 1 in this sector.

Finally, the air containing moisture is recirculated from the suction hood 3 through ducts 12 to the bottom hood 2, or more precisely to the burners 9 mounted there, so that the air can be heated again. If necessary, some of the air containing moisture can be carried off through a duct 14 before it reaches the burners 9 and the equivalent amount of fresh air can be fed in through a duct 15.

As mentioned, a fan can be installed in the suction hood 3 to extract the air containing moisture from the drum 1. If this fan is sized to provide the appropriate capacity, it may be possible to do without the fan 10 in the bottom hood 2 under certain circumstances. Similarly, it would be possible to integrate the burners 9 into the suction hood 3 and only install a fan in the suction hood, for example, or leave the fans 10 in the bottom hood 2 only.

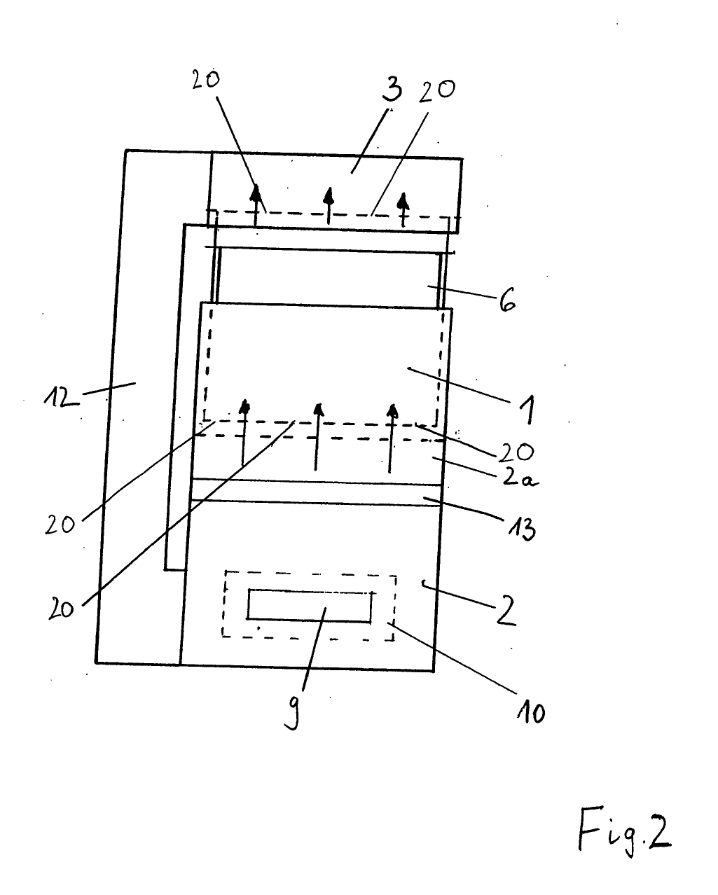

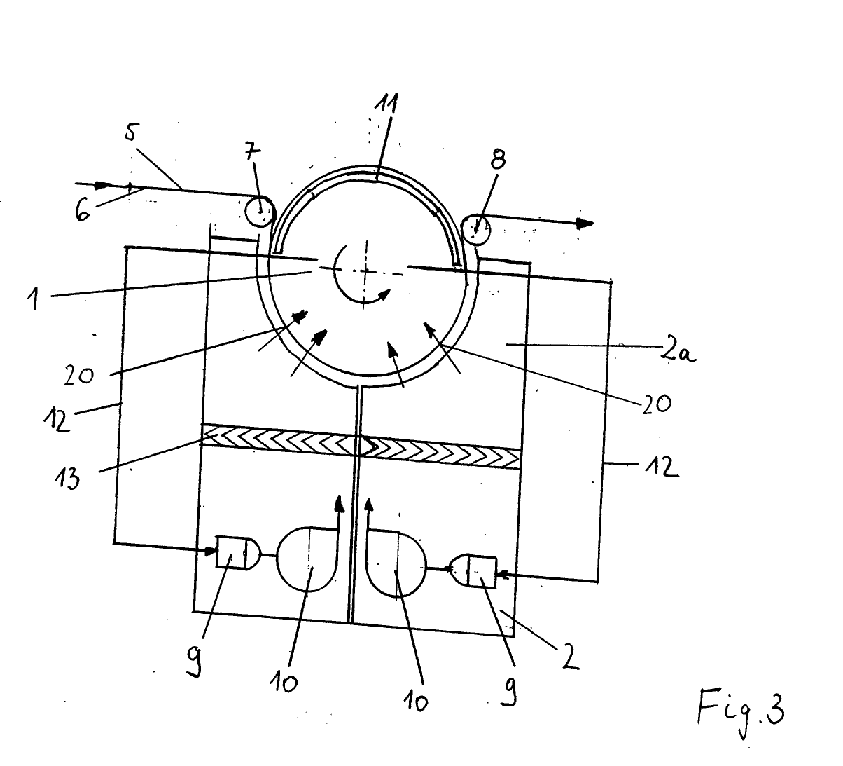

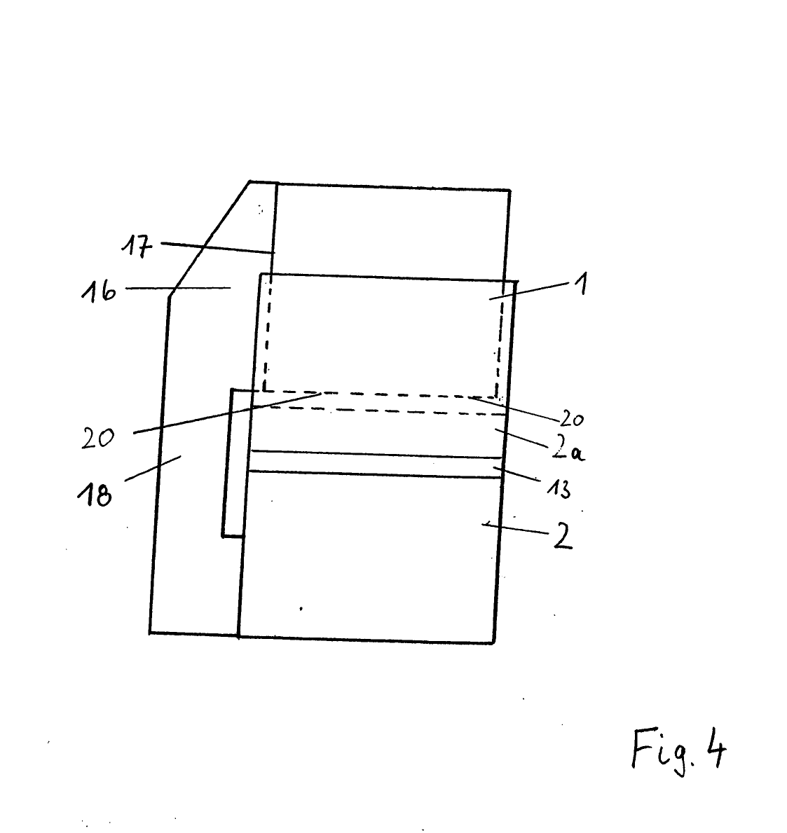

In the embodiment shown in FIGS. 3 and 4, the bottom hood 2, is designed in the same way as the embodiment shown in FIGS. 1 and 2. Instead of the suction hood 3, a device 16 to carry off the air containing moisture is mounted on the face end of the drum 1. In this case, the drying drum 1 is open at the end 17 facing the suction device 16, and the entire area of the cylinder wall 4 outside the bottom hood 2 is sealed off on the inside of the cylinder wall 4 with a seal 11. The device 16 to carry off the air containing moisture is also connected to a duct 18 that leads to one or more burners 9 and fans 10 in the bottom hood 2, as in the embodiment according to FIGS. 1 and 2.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. Apparatus for drying a paper web comprising:
at least one hood;
a heating device for generating hot air, the heating device being disposed within the at least one hood;
a housing surrounding the at least one hood;
a drying drum including a cylinder wall defining a plurality of apertures for the passage of the hot air through the cylinder wall, the drying drum being mounted at least partially inside the housing, the at least one hood at least partially enclosing the cylinder wall of the drying drum;
a feed device for applying the hot air to the paper web; and
a device for carrying off the air containing moisture.

2. The apparatus of claim 1 wherein the heating device is a burner.

3. The apparatus of claim 1 wherein the feed device and the heating device are disposed inside the hood.

4. The apparatus of claim 3 further comprising a device for distributing and evening out the flow located between the heating device and the feed device.

5. The apparatus of claim 1 wherein the device for carrying off the air containing moisture is a suction hood, which partially encloses the cylinder wall of the drying drum and which is surrounded by the housing.

6. The apparatus of claim 5 wherein the heating device is located in the suction hood.

7. The apparatus of claim 1 wherein the drying drum has one open face end and the device for carrying off air containing moisture is connected to the open face end.

8. The apparatus of claim 1 wherein a portion of the cylinder wall is not enclosed by the hood, the apparatus further comprising a seal disposed proximate to the device for carrying off the air containing moisture and the portion of the cylinder wall that is not enclosed by the hood.

9. The apparatus of claim 8 wherein the seal is located on the inside of the cylinder wall.

10. The apparatus of claim 1 wherein the device for carrying off air containing moisture has a suction device.

11. The apparatus of claim 1 wherein the feed device has a fan.

12. The apparatus of claim 1 further comprising an additional device to carry off some of the air containing moisture and feed in fresh air, said additional device being mounted upstream of the heating device.
